(19) United States
(12) Patent Application Publication
(10) Pub. No.: US 2016/0242422 A1
(43) Pub. Date: Aug. 25, 2016

(54) AGRICULTURAL COMPOSITION CONTAINING CHITIN AND CHITINASE-PRODUCING BACTERIA FOR TREATING SOIL AND PLANTS

(71) Applicants: Mark C. Elizer, Wellington, FL (US); Ronald W. Reed, Indian Trail, NC (US)

(72) Inventors: Mark C. Elizer, Wellington, FL (US); Ronald W. Reed, Indian Trail, NC (US)

(21) Appl. No.: 15/046,913

(22) Filed: Feb. 18, 2016

Related U.S. Application Data
(60) Provisional application No. 62/118,244, filed on Feb. 19, 2015.

(51) Int. Cl. A01N 63/02; A01N 25/26

(52) U.S. Cl. CPC A01N 63/02; A01N 25/26

(57) ABSTRACT

A composition for protecting plants against chitinous pathogens and/or treating infestations of chitinous pathogens comprises pellets which include a source of chitin and a bacteria capable of producing chitinase. In certain embodiments, the bacteria are in the form of spores. In some embodiments, the pellets may include a binder material. In some embodiments, the chitin source may form a core of each pellet and the core may be at least partially surrounded by one or more layers of the bacteria.

### CROSS-REFERENCE TO RELATED APPLICATIONS

This application claims priority under 35 U.S.C. §119(e) to commonly owned, co-pending U.S. Provisional Application Ser. No. 62/118,244 filed Feb. 19, 2015, for all commonly disclosed subject matter.

### STATEMENT REGARDING FEDERALLY SPONSORED-RESEARCH OR DEVELOPMENT

Not Applicable.

### INCORPORATION BY REFERENCE

U.S. Provisional Application Ser. No. 62/118,244 is expressly incorporated herein by reference in its entirety to form a part of the present disclosure.

### FIELD OF THE INVENTION

This relates to the field of agricultural soil amendments and, more particularly, to using agricultural soil amendments to protect plants against pests.

### BACKGROUND

Plant pathogens such as pests often reside in the soil and attack plants through their foliage and/or root systems. The modern, conventional method of protecting plants against soil-borne pathogens involves applying a synthetic pesticide to the soil. This method often destroys the target pests, but, unfortunately, also often destroys non-target soil-borne organisms that benefit the plants. Some of those non-target soil-borne organisms may actually stimulate the plants' natural defenses to pests. Destroying the beneficial organisms is, therefore, undesirable.

Many agricultural pests, such as nematodes, have a shell containing chitin at some point during their life cycle. Chitin is a naturally abundant polysaccharide material, also found in the outer shell of crustaceans such as lobster, crab, shrimp, and crawfish, for example.

Chitin is not water soluble, but is converted to a water soluble compound called “chitosan” by an enzyme called “chitinase.” Because chitinase can covert water-insoluble chitin to water-soluble chitosan, it can also damage the shell of chitinous pests by converting the chitin in the shell to chitosan, thereby exposing the internal organs of those pests to the environment.

Some plant species are able to sense the presence of chitin or chitosan in the proximate soil environment. The presence of chitin and/or chitosan triggers a natural defense mechanism in those plants, which involves stimulating plant growth, and producing some chitinase. But these plants produce chitinase in very small quantities.

Some species of soil-borne bacteria and fungi produce chitinase and feed on chitin, but these organisms are often destroyed by the modern, conventional pesticides.

Chitosan and chitin are both used in agriculture to treat soil and/or plants. Chitosan is conventionally applied to plants, seeds, or soil directly. Although this method of applying chitosan is at least marginally effective, it has several drawbacks. First, it is expensive to produce chitosan from chitin. Second, applying chitosan directly to plants, seeds, and/or soil does not provide a sustained dose of chitosan over a period of time to the soil or plant.

Chitin is conventionally used in agriculture by applying crushed crustacean shells directly to the soil. This supplies the soil with plant micro-nutrients. Applying chitin alone directly to soil has not proven to be a reliable method of pest control.

### SUMMARY

In view of the foregoing, an agricultural composition has been developed. The agricultural composition contains both chitinase-producing bacteria and particulate chitin as a food source for the bacteria. The composition supplies chitinase, chitin, and chitosan to the soil for treating plants against chitinous plant pathogens.

An agricultural composition that embodies this principle comprises a plurality of pellets that contain a particulate chitin source and chitinase-producing bacteria. The pellets may be dispersed about the soil in proximity to a plant to be treated

### BRIEF DESCRIPTION OF THE DRAWING

FIG. 1 is a flow diagram of an exemplary method of making an agricultural composition in accordance with a method embodiment.

### DETAILED DESCRIPTION OF PREFERRED EMBODIMENTS

Exemplary embodiments of the present composition are first described. The composition includes a plurality of distinct pellets that are dispersible about an area to be treated. The pellets contain a plurality of chitin-containing particulates from a chitin source, preferably in particulate form, and chitinase-producing bacteria.

The pellets are solid, granular-objects that may be distributed about soil in a similar fashion to conventional solid fertilizer granules or pellets. The shape of the pellets depends on how they are formed. Suitable shapes include, but are not limited to spheroids, cylindroids, or the like. Production of the pelletized composition using conventional pelletizing equipment, such as a rotating disc pelletizer, will typically result in spheroidal or cylindroidal pellets. The pellets may have a major dimension of about 0.1 mm to about 5 mm, about 0.2 mm to about 1 mm, or about 0.4 mm to about 3.5 mm. The major dimension is the largest dimension present on a pellet. For spheroidal pellets, the major dimension is the diameter. For cylindrical pellets the major dimension is the length. The desired shape and size of the pellets may vary depending on the application.

The pellets may be administered to the soil by spreading or dispersing them about the soil in proximity to a plant in need of treatment. They may be dispersed, for example, using a conventional pellet spreading technique using a mechanical spreader or by hand. In a typical application, a known amount of the composition will be applied to a known surface area to be treated, in a similar manner to how conventional fertilizer granules are spread.

The chitin source includes particulate matter containing chitin. Many naturally occurring materials, including crustacean shells, contain chitin. The chitin source may, therefore, include chitin particulates from a natural chitin-containing material, such as crushed or ground crustacean shells.

In the composition, the particulate chitin source is in the form of particles to provide substantial chitin surface area on which the chitinase-producing bacteria can feed. An example of a preferred major dimension of the particulates may be about 20 micrometers to about 60 micrometers. In a particular embodiment, the median major dimension of the particulate chitin source is not greater than about 44 micrometers. At this size, the particulate chitin source resembles a powder or powder-like material.

Preferably, the pellets contain 25% w/w to 75% w/w, 65% w/w to 75% w/w, or 65% w/w to 70% w/w of the particulate chitin source. As used here, % w/w refers to the percent by weight of a component in a pellet compared to the total weight of the finished pellet.

Because chitin is a component of the shell or exoskeleton of many crustaceans. Crustacean shells are an abundant and suitable chitin source. The chitin-containing particulates used in the composition may be prepared from crustacean shells by turning the shells themselves into the particulate material by crushing, grinding, milling or pulverizing them.

Advantageously, because crustacean shells are a commercial byproduct from food processing facilities, converting the waste shells from food-processing facilities into the particulate chitin source for use in the composition provides a means for recycling the waste shells into an environmentally beneficial material.

If waste crustacean shells are used, the particulate chitin source may also contain proteinaceous material that was not completely removed from the shells prior to converting them into particulate material. The proteinaceous material is typically residual meat and/or connective tissue that is bound to the shell.

The chitinase-producing bacteria in the composition include at least one bacteria type that is capable of producing the enzyme chitinase, which converts the chitin in the particulate chitin source to chitinase over time on or in the soil. Chitinase-producing bacteria include those of genus Bacillus, Streptomyces, Enterobacter, Pseudomonas, and Arthrobacter. The composition may contain bacteria from a single genus or from more than one genus of chitinase-producing bacteria. A particular example of a chitinase-producing bacteria species is Streptomyces krainskii.

The absolute amount of chitinase-producing bacteria present in the finished pellets is not critical. The amount of bacteria to be used in a treatment regimen may be estimated based on the volume of a bacteria inoculant solution applied to the pellets and the viscosity of the inoculant solution. The viscosity is directly proportional to the bacteria concentration of the inoculant solution. By way of example, in a treatment regimen, enough inoculant solution is added to the pellets so that one gallon of inoculant solution is applied to the number of pellets to be applied per one acre. The pellet distribution rate to the soil may be, for example, about 10 lbs. per 1000 ft² of surface to be treated.

The chitinase-producing bacteria in the composition may be in the spore and/or the non-spore form. Although not always necessary, it may be advantageous for the composition to include some bacteria in the spore form because those bacteria will be robust so as to withstand unfavorable environmental conditions that may adversely affect some of the bacteria in the non-spore form. In some cases, therefore, including bacteria in the spore form may assist with longer-term storage.

After the composition is dispersed over the area to be treated, a suitable combination of water and temperature will activate the bacteria spores, allowing the bacteria to produce chitinase. The residual moisture content of pellets is preferably below that which would activate a substantial number of the spores before dispersion about the treatment area.

The ingredients in the pellets are held together with a binder. The binder is a water soluble, agriculturally acceptable material adapted to hold or adhere the ingredients together when the pellets are dried. The binder is effective to prevent the pellets from substantially disintegrating until after they are dispersed on the treatment area. Examples of binders include, but are not limited to lignins, sugars, and other water soluble organic binders. Example of lignin-based binders include ammonium lignosulfonate and/or calcium lignosulfonate. Other examples of binders include molasses, corn starch, water glass (sodium silicate), and polyethylene glycol.

Preferably, the pellets contain 2-6% w/w, 3% w/w to 5% w/w, or 4% w/w to 5% w/w binder.

The pellets may also contain a filler that is adapted to modify the integrity of the pellet for assisting with the pelletizing process. Some examples of fillers include, but are not limited to, silicas such as calcium silicate, calcium carbonate, gypsum, fly ash and/or organic matter such as feather meal, chicken manure waste, and peat. The filler may also contain fertilizer compounds that contain one or more plant nutrients such as nitrogen, phosphorus, and/or potassium.

In an exemplary embodiment, the filler is calcium silicate. Calcium silicate is particularly advantageous because it also functions as plant nutrient source by providing both calcium and silicon to plants.

The pellets preferably contain 15% w/w to 50% w/w, or 15% w/w to 25% w/w filler. The amount of filler may be adjusted to obtain the desired pellet consistency for a particular composition or application.

The processing steps, described below, involve using a solvent, such as water, to prepare the pellets. The pellets, therefore, may contain residual solvent. When water is used, the pellets preferably contain 1% w/w to 5 w/w or 1% w/w to 3% w/w water.

The water content affects the bacteria spores and the integrity of the pellets. If the water content is too low, less than about 1% in many cases, the pellet can fall apart because the binder is overly dehydrated, but if the water content is too high, more than about 5%, the water may activate the bacteria spores. It is preferable to avoid activating the bacterial spores until after the pellets are dispersed in the area to be treated. Thus, depending on the bacteria used, the water content of the pellet may be adjusted so as to avoid activating a substantial number of the spores prior to dispersion.

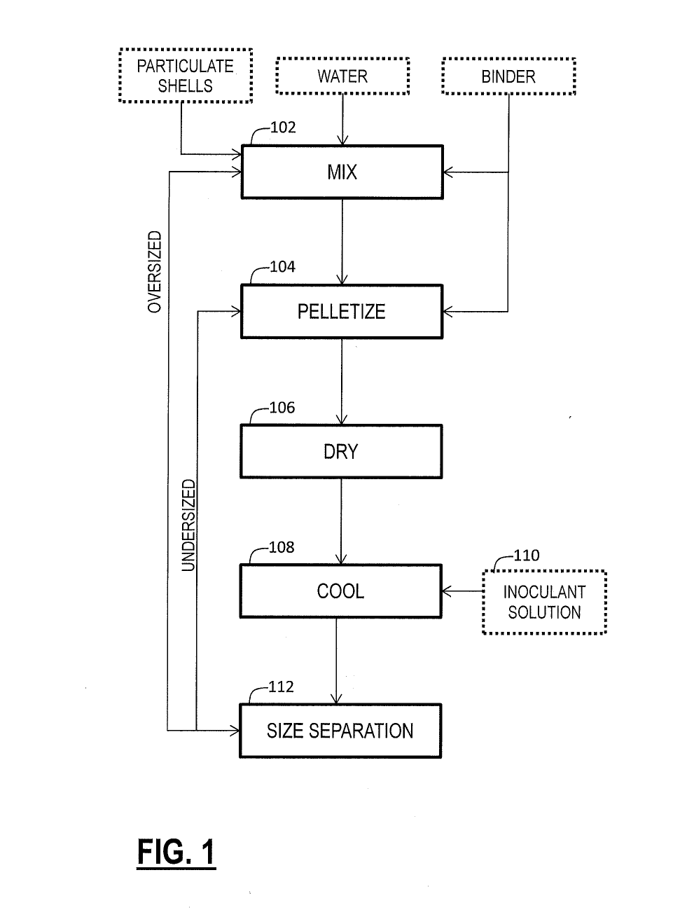

An exemplary method of making the composition is now described with reference to FIG. 1.

An inoculant solution 100 containing the chitinase-producing bacteria is prepared for combining with the other pellet ingredients. The inoculant solution is a mixture of water and chitinase-producing bacteria. The quantity of bacteria in the solution corresponds to the viscosity of the solution. In a preferred example of the inoculant solution the viscosity is 60 to 200 centistokes.

The inoculant solution is prepared by mixing, at a temperature of 60-75 degrees F., a concentrated, refrigerated inoculant with distilled water. The ratio of concentrated inoculant to water is, for example, 1-5 parts concentrated inoculant to one part water. The solution that forms is mixed for several minutes prior to applying it to pellets.

If the chitin source is a commercial by-product, such as waste crustacean shells, the shells are initially shredded and dried. The drying process may be expedited by heating the shredded shells, but the temperature preferably does not exceed 325 degrees F. A preferred temperature range for drying the shredded shells is 250 degrees F. to 325 degrees F. Drying may be performed in a drying apparatus such as a fluid bed dryer with substantially constant agitation or another conventional drying apparatus.

Depending on the condition of the shells, optional pre-processing steps may be desirable to treat the shells prior to shredding them. For example, if the raw shells have not already been cleaned, they may produce a noxious odor due to decomposing organic matter. The raw shells may be pre-treated by blending them in a solution of water and calcium oxide, also known as quicklime. Quicklime or hydrated lime raises the pH of the liquid killing bacteria responsible for putrefaction of organic matter. The calcium oxide is caustic and substantially reduces the odor caused by bacterial action on the organic portion of the waste.

The dried shells are reduced to smaller particulates by milling, grinding, or the like, which may be carried out in a conventional milling apparatus, for example. A particular example of the grinding process includes grinding the shells in a closed loop vibratory or rotary ball mill to the preferred size. The preferred median size for the major dimension of the particulates is 10 micrometers to 100 micrometers, 20 micrometers to 60 micrometers. The preferred size particulates may be separated using a sieve or mesh, such as one having openings of about 44 micrometers with a D50 size distribution, for example.

If the optional pre-processing steps are not performed, the method begins at Block 102. At Block 102, the particulate shells are blended with water, binder, and filler to form seed pellets or granules. The blending process may be performed in a mechanical mixer, such as controlled speed pin mixer, to expedite mixing the components. The resulting granules are substantially spheroidal and preferably have a diameter of about 0.2 mm to about 1 mm. The ultimate diameter of the granules may be adjusted to achieve the desired size by adjusting the blending speed.

At Block 104, the granules are placed in a pelletizer, such as a pelletizing disc, to increase the size. If a pelletizing disc is used, the disc rotates at an inclined angle, causing the seed pellets to climb and cascade down the face of the disc in a snowball-like manner as they increase in diameter and compact to a substantially spheroidal form until the desired size is achieved. The pelletizer may be operated at ambient temperature.

If desired, an additional amount of binder is added to the pelletizer to enhance adhesion of fine particles to the exterior of the pellets to increase their diameter.

At Block 106, wet pellets from the pelletizer are subsequently dried, preferably in an active drier such as a low attrition dryer. During the drying process, water evaporates from the pellets and the binder hardens to maintain the shape of the pellets.

Drying is preferably performed in a fluidized bed in which heated, pressurized air flows through the pellets to evaporate water. The drying parameters such as the feed rate, fluidizing air temperature, and air velocity may be adjusted as desired to obtain the desired water content of the pellets and maintain temperatures below that which would destroy the chitin structure.

At Block 108, the dried pellets are cooled to a temperature of between about 80 degrees F. to about 110 degrees F. or about 90 degrees F. to about 110 degrees F. If the pellets are over-dried, the binder may dehydrate too much to maintain the structural integrity of the pellets. An active cooler may be used to expedite the cooling process. An example of an active cooler that may be used is a fluid bed cooler that passes controlled velocity and temperature air through and across a conveying bed to remove heat and unwanted moisture from the pellets.

At Block 110, the inoculant solution is preferably applied during the cooling process by spraying it onto the cooling pellets to obtain substantially uniform surface coverage. The inoculant solution also penetrates pores in the surface of the cooling pellets. The temperature of the cooling pellets is below a temperature that might kill the bacteria. Typically, this is below about 120 degrees F., but may depend on the bacteria. As the pellets cool, water from the inoculant solution substantially evaporates. To assist with the drying process, the cooling process may be controlled by maintaining the temperature from about 90 degrees F. to 110 degrees F. The inoculated pellets are allowed to dry until the desired water content is achieved.

At Block 112, inoculated pellets are separated by size. This may be achieved using a mechanical sifter such as a vibratory sifter or the like. Oversize pellets may be recycled by grinding them and feeding them back to the mixer. Undersize pellets may be fed back into the pelletizing disc to increase their size. A preferred size range of the pellets based on their major dimension is about 0.1 mm to about 5 mm, about 0.2 mm to about 1 mm, or about 0.4 mm to about 3.5 mm. The preferred size typically depends on the application.

In an example of a particular embodiment of the composition, the composition comprises 25%-75% w/w particulate chitin source, 2%-6% w/w binder, 1%-5% w/w water, 15%-50% w/w filler, and 0.1%-1% w/w bacteria inoculant.

In another example of a particular embodiment of the composition, the composition comprises 65%-75% w/w particulate chitin source, 4%-6% w/w binder, 1%-3% w/w water, 15%-25% w/w filler, and 0.1%-1% w/w bacteria inoculant.

As mentioned above, the composition may be used to treat plants against chitinous plant pathogens. A “chitinous plant pathogen” is an organism that is pathogenic to plants and contains chitin at some point during its life cycle. Chitinous plant pathogens include at least some nematodes, fungi, and insects.

The composition, when applied to soil can treat a chitinous plant pathogen infestation by several mechanisms. First, it can stimulate plants natural defenses, which sometimes includes producing chitinase. Some plants are able to detect the presence of chitin or chitosan in the soil and produce chitinase in response. Second, it provides both a source of chitinase producing bacteria and a chitin food source to the soil to ensure that chitinase-producing bacteria will remain alive in the soil to produce sufficient chitinase for treating chitinous pests.

### EXAMPLES

This section provides specific examples of the composition, an exemplary process for making it, and a method of using it. The scope of the possible embodiments is not limited to what these examples teach.

### Example 1: Pellet Preparation

Lobster shell waste from a commercial seafood production facility was shredded in a low-speed, high-torque shredder to a granular size of ⅜″ and finer. The shredded shells exiting the shredder were introduced to a screw filter, which removed most of the liquid from the shells.

The granular shells were blended with 10% w/w commercial grade hydrated lime at a rate required to elevate the pH of the shell slurry and to chemically stabilize excess free water for storage and handling. The shell slurry was oven dried at 300 degrees F. to remove residual free water.

The dried granular shells were introduced to a high speed vibratory ball mill for sufficient time to reduce the dry shells to a median size of about 44 microns (D50).

The powdered shells were fed to a pilot scale rotary pelletizing disc with water, ammonium lignosulfonate, and calcium silicate to produce substantially spheroidal pellets having a diameter of 0.2 mm to about 1 mm before drying.

The dry pellets were sprayed manually during agitation to thoroughly damp coat the exterior surface of each individual pellet with bacterial inoculant solution. The bacteria in the inoculant solution from a Streptomyces strain. The inoculated pellets were dried at a temperature of about 120 degrees F.

The pellets contained about 68% w/w particulate chitin source, 10% w/w lime, 15% w/w calcium silicate filler, 5% w/w ammonium lignin sulfonate binder, about 2% water, and bacteria from the inoculant solution.

### Example 2: Field Tests

Field tests are underway in a greenhouse environment. A nematode population is added to sterilized native soil. A variety of agricultural plant varieties indigenous to the environment are planted in the nematode infested soil. Various amounts of pellets of the agricultural treatment composition are added to the soil. The root structure development and nematode count reduction are compared to a control sample over the growth cycle. The treated plants show improved root structure and a reduction in the nematode population.

This disclosure describes preferred embodiments, but not all possible embodiments of the compositions and methods. Where a particular feature is disclosed in the context of a particular composition or method, that feature can also be used, to the extent possible, in combination with and/or in the context of other embodiments of the compositions and methods. The compositions and methods may, be embodied in many different forms and should not be construed as limited to only the embodiments described here.

What is claimed is:

1. An agricultural composition for treatment of plants against chitinous plant pathogens, the composition comprising a plurality of distinct pellets that are dispersible about an area to be treated, the pellets comprising a particulate chitin source and chitinase-producing bacteria.

2. The agricultural composition of claim 1, wherein the particulates of the particulate chitin source are bound together to form a solid core and the chitinase-producing bacteria are over the solid core.

3. The agricultural composition of claim 1, wherein the pellets further comprise a water-soluble binder that adheres the particulates of the particulate chitin source together

4. The agricultural composition of claim 1, wherein at least a portion of the chitinase-producing bacteria are in spore form.

5. The agricultural composition of claim 1, wherein the composition comprises 25%-75% w/w particulate chitin source, 2%-6% w/w binder, 1%-5% w/w water, 15%-50% w/w filler, and 0.1%-1% w/w bacteria inoculant.

6. A method of treating a plant for protection against a chitinous plant pathogen, the method comprising administering an agricultural composition effective against a chitinous plant pathogen to a plant in need thereof, the agricultural composition comprising a plurality of distinct pellets that are dispersible about an area to be treated, the pellets comprising chitin-containing particulates and chitinase-producing bacteria.

7. The method of claim 6, wherein the agricultural composition is administered by an applying the pellets to soil in proximity to the plant.

8. The method of claim 6, wherein the particulates of the particulate chitin source are bound together to form a solid core and the chitinase-producing bacteria are over the solid core.

9. The method of claim 6, wherein at least a portion of the chitinase-producing bacteria are in spore form.

10. The method of claim 6, wherein the agriculture composition comprises 25%-75% w/w particulate chitin source, 2%-6% w/w binder, 1%-5% w/w water, 15%-50% w/w filler, and 0.1%-1% w/w bacteria inoculant.

11. The method of claim 6, wherein the chitinous plant pathogen includes nematodes.

12. A method of making an agricultural composition, the method comprising:
forming inoculated pellets containing a particulate chitin source and chitinase-producing bacteria by contacting granules containing the particulate chitin source with chitinase-producing bacteria; and
drying the inoculated pellets.

13. The method of claim 12, wherein:
the particulates of the particulate chitin source in the granules are bound together; and
the granules are contacted with the chitinase-producing bacteria by applying an inoculant solution containing the chitinase-producing bacteria to the granules.

14. The method of claim 13, wherein the inoculant solution is applied in such a way that it substantially covers an outer surface of the granules.

15. The method of claim 12, wherein the granules are contacted with the chitinase producing bacteria while a temperature of the granules is about 90 degrees F. to about 110 degrees F.
